(19) United States
(12) Patent Application Publication
(10) Pub. No.: US 2019/0219115 A1
(43) Pub. Date: Jul. 18, 2019

(54) BRAKE DISC

(71) Applicant: ADVICS CO., LTD., Kariya-shi, Aichi-ken (JP)

(72) Inventor: Koichi Hashida, Kariya-shi, Aichi-ken (JP)

(73) Assignee: ADVICS CO., LTD., Kariya-shi, Aichi-ken (JP)

(21) Appl. No.: 16/307,042

(22) PCT Filed: Jun. 7, 2017
(86) PCT No.: PCT/JP2017/021171

§ 371 Date: Dec. 4, 2018

(30) Foreign Application Priority Data
Jun. 7, 2016 (JP) 2016-113301
Jun. 7, 2016 (JP) 2016-113302

(51) Int. Cl. F16D 65/12

(52) U.S. Cl. CPC F16D 65/123; F16D 65/0006; F16D 65/128

(57) ABSTRACT

A brake disc applies braking torque to a vehicle wheel by sliding against friction pads. The brake disc is configured from at least one or more auxiliary discs that slide against the friction pads, main discs in surface contact with the auxiliary discs at surfaces on the sides opposite the surfaces against which the auxiliary discs and friction pads slide, and a hat member that secures the main discs and the auxiliary disc in a state of being capable of slight displacement relative to each other.

### TECHNICAL FIELD

The present invention relates to a brake disc.

### BACKGROUND ART

Patent Document 1 discloses that in order “to obtain a brake disc that does not generate abnormal noise”, “at least two discs having different frequencies from each other overlap each other, and both are bound to each other at a plurality of positions which are distributed so as to impart a degree of freedom to each other”. Specifically, in the description, the two discs are integrally bound with rivets in a part of the discs that slide against brake pads.

In the brake disc described in Patent Document 1, the two discs are secured to each other with multiple rivets at the parts that are in contact with the brake pad (also referred to as a “friction pad”). Therefore, a structure thereof is complicated. In addition, abrasion powder of the friction pad is accumulated in a through-hole for the rivet, and thus there is a concern about abnormal noise (brake squeal) due to the abrasion powder.

### CITATION LIST

Patent Document
Patent Document 1: JP-B-50-035179

### SUMMARY OF THE INVENTION

### Technical Problem

An object of the invention is to provide a brake disc having at least two overlapping discs, in which assembly is simplified and it is possible to reliably reduce brake squeal.

### Solution to Problem

A brake disc (BRD) according to the invention applies braking torque to a vehicle wheel (WH) by sliding against friction pads (MPO and MPI) and is configured from at least one or more auxiliary discs (BDH and BDI) that slide against the friction pads (MPO and MPI), main discs (BDS) in surface contact with the auxiliary discs (BDH and BDI) at surfaces (Mhq and Mhr) on sides opposite surfaces (Mhp and Mhs) against which the auxiliary discs (BDH and BDI) and the friction pads (MPO and MPI) slide, and a hat member (HTB) that secures the main discs (BDS) and the auxiliary discs (BDH and BDI) in a state of being capable of slight displacement relative to each other.

According to the above-described configuration, there is friction between contact surfaces of the main disc BDS and the auxiliary disc (at least one of BDH and BDI), and thus brake squeal is reduced due to friction attenuation when the discs rub against each other. In addition, the brake disc is not configured from one member but is configured from two separate members of the main disc BDS and the hat member HTB. In addition, the main disc BDS and the auxiliary discs BDH and BDI are secured to the hat member HTB, and thus it is possible to improve assemblability of the entire brake disc BRD.

### BRIEF DESCRIPTION OF THE DRAWINGS

FIG. 1 is a sectional view for describing a first embodiment of a brake disc according to the invention.

FIG. 2 is a sectional view for describing a second embodiment of the brake disc according to the invention.

FIG. 3 is a sectional view for describing a third embodiment of the brake disc according to the invention.

FIG. 4 is a partial sectional view for describing an example of an auxiliary disc.

FIG. 5 is a schematic view for describing another example of the auxiliary disc.

FIG. 6 is a sectional view for describing a fourth embodiment of the brake disc according to the invention.

FIG. 7 is a sectional view for describing a fifth embodiment of the brake disc according to the invention.

FIG. 8 is a sectional view for describing a sixth embodiment of the brake disc according to the invention.

FIG. 9 is a partial sectional view for describing an example of an auxiliary disc.

FIG. 10 is a schematic view for describing another example of the auxiliary disc.

FIG. 11 is a sectional view for describing a seventh embodiment of the brake disc according to the invention.

FIG. 12 is a sectional view for describing an eighth embodiment of the brake disc according to the invention.

FIG. 13 is a sectional view for describing a ninth embodiment of the brake disc according to the invention.

### MODE FOR CARRYING OUT THE INVENTION

### First Embodiment of Brake Disc According to Invention

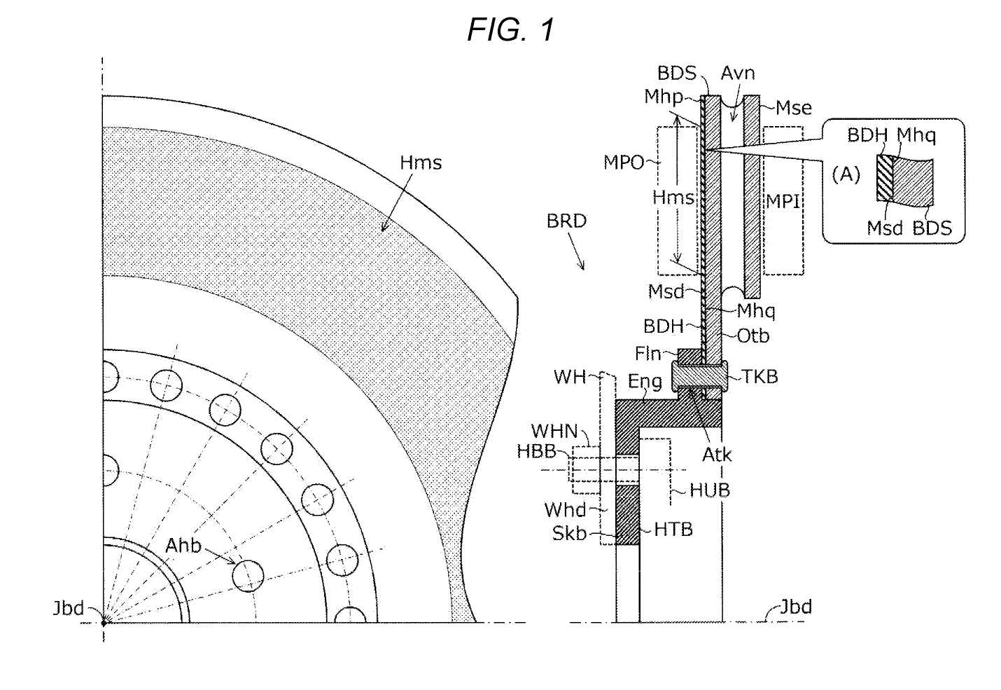

With reference to a sectional view in FIG. 1, a first embodiment of a brake disc BRD according to the invention will be described. The brake disc BRD is a friction disc of a disc-type braking device that is employed to brake a vehicle wheel WH in a vehicle.

The brake disc BRD is secured to rotate integrally along with the vehicle wheel WH, by a hub bolt HBB embedded in a hub unit HUB. Specifically, the hub bolt HBB extending from the hub unit HUB penetrates an attachment hole Ahb that is open in the brake disc BRD and a wheel disc portion Whd of the vehicle wheel WH and is fastened by a wheel nut WHN.

The brake disc BRD is sandwiched between two friction pads MPO and MPI. Here, an outer-side pad MPO is positioned on a side close to the wheel disc portion Whd of the vehicle wheel WH (that is, an exterior side of the vehicle in a right-left direction), and an inner-side pad MPI is positioned on a side farther apart from the wheel disc portion Whd of the vehicle wheel WH (that is, an interior side of the vehicle in the right-left direction). The brake disc BRD is sandwiched between the friction pads MPO and MPI, and a friction force is generated during braking. The vehicle wheel WH exhibits a braking force due to the friction force.

The brake disc BRD is configured from a main disc BDS, an auxiliary disc BDH, a hat member HTB, and a fastening member TKB. Incidentally, the “outer side” indicates the exterior side of the vehicle in the right-left direction, and the “inner side” indicates the interior side of the vehicle in the right-left direction.

The main disc BDS is a member molded into an annular shape. The main disc BDS is in sliding contact with the inner-side friction pad MPI on a main-disc inner surface Mse (flat surface) that is positioned on an outer-circumferential portion such that the vehicle wheel WH (tire) generates the braking force. In addition, the main disc BDS is provided with a plurality of air holes (passages of air) Avn therein for dissipating heat. The main disc BDS is a so-called ventilated disc. For example, it is possible to employ cast iron as a material of the main disc BDS. This is because the cast iron has a high vibration damping property.

The auxiliary disc BDH is a member having a thin plate shape formed into an annular shape and overlaps the main disc BDS so as to be in surface contact therewith. Hence, the main disc BDS and the auxiliary disc BDH are not in point contact or line contact with each other. Similarly to the main disc BDS, the auxiliary disc BDH integrally rotates along with the vehicle wheel WH. The auxiliary disc BDH is in sliding contact with the outer-side friction pad MPO on an auxiliary-disc outer surface Mhp (flat surface) that is positioned on the outer-circumferential portion such that the vehicle wheel WH (tire) generates the braking force. Here, in a case where the brake disc BRD rotates, a part in which the auxiliary disc BDH and the friction pad MPO slide against each other is a sliding range Hms. For example, it is possible to employ a steel plate as a material of the auxiliary disc BDH. Incidentally, the auxiliary disc BDH is not provided with the air hole.

Each flat surface of the main disc BDS and the auxiliary disc BDH will be described. In the main disc BDS, the flat surface (sliding surface) that is in contact with the inner pad MPI is the main-disc inner surface Mse. A flat surface on an opposite side (back side) of the main-disc inner surface Mse is a main-disc outer surface Msd. In the auxiliary disc BDH, the flat surface (sliding surface) that is in contact with the outer pad MPO is the auxiliary-disc outer surface Mhp. A flat surface on an opposite side (back side) of the auxiliary-disc outer surface Mhp is an auxiliary-disc inner surface Mhq.

The main disc BDS and the auxiliary disc BDH overlap each other. Therefore, the main-disc outer surface Msd and the auxiliary-disc inner surface Mhq are in surface contact with each other. The main-disc outer surface Msd and the auxiliary-disc inner surface Mhq are contact surfaces. During the braking, the main disc BDS and the auxiliary disc BDH receive a force so as to be sandwiched between the friction pads MPO and MPI. Hence, contact surface pressure of the main-disc outer surface Msd and the auxiliary-disc inner surface Mhq increases more during the braking than during non-braking.

The main disc BDS and the auxiliary disc BDH are provided with a plurality of assembly holes Atk in inner circumferential parts thereof so as to be assembled with the hat member HTB. The assembly hole Atk is a through-hole in each of the disc members BDS and BDH. Here, a part of the main disc BDS on the outer side (side apart from the center of the vehicle in the right-left direction) with respect to the air hole Avn extends in a direction of a rotation axis Jbd (that is, a direction of the hat member HTB), and the main disc is provided with the assembly hole Atk in an inner-circumferential portion Otb thereof. Hence, the outer inner-circumferential portion Otb is a connection portion between the hat member HTB and the main disc BDS.

The hat member HTB is a bottomed cylindrical member that has a flange portion Fln in an outer-circumferential portion Eng and extends in the rotation axis Jbd direction of the brake disc (the rotation axis being the same as a rotation axis of the vehicle wheel WH). The hub unit HUB is provided inside a cylinder of the hat member HTB. A bottom portion Skb of the hat member HTB is provided with a plurality of attachment holes (through-holes) Ahb. The hub bolt HBB of the hub unit HUB penetrates the attachment hole Ahb and is tightened by the wheel nut WHN, with the wheel disc Whd of the vehicle wheel WH pinched therebetween. In other words, the hub unit HUB, the hat member HTB, and the vehicle wheel WH are integrally joined by the hub bolt HBB and the wheel nut WHN. For example, it is possible to employ an aluminum alloy as a material of the hat member HTB.

The flange portion Fln of the hat member HTB is provided with the plurality of assembly holes (through-holes) Atk such that the main disc BDS and the auxiliary disc BDH are assembled with the hat member. The fastening member TKB penetrates the assembly hole Atk of each of the members HTB, BDS (particularly, the outer inner-circumferential portion Otb), and BDH. Thus, the three members HTB, BDS, and BDH are fastened by the fastening member TKB. Specifically, the fastening member TKB is a caulking member (for example, a rivet or a grommet), and an end portion thereof is plastically deformed. In this manner, the hat member HTB, the auxiliary disc BDH, and the main disc BDS are secured to each other in this order from the outer side. In other words, the brake disc BRD is formed as one disc in which two discs (the main disc BDS and the auxiliary disc BDH) overlap each other and are secured by the hat member HTB and the fastening member TKB. A hole diameter of the assembly hole Atk is slightly larger than a diameter of the fastening member TKB in a penetrating portion. Therefore, in a secured state in the disc rotation axis Jbd direction, the main disc BDS and the auxiliary disc BDH are in a state of being capable of slight displacement relative to each other within a contact surface. The vehicle wheel WH, the hub unit HUB, the hat member HTB, the main disc BDS, and the auxiliary disc BDH are coaxially secured. Hence, the disc rotation axis Jbd is the rotation axis of the vehicle wheel WH, the hub unit HUB, the hat member HTB, the main disc BDS, and the auxiliary disc BDH.

The “slight displacement” is displacement larger than an amplitude of brake squeal in a case where the brake squeal is generated. The brake squeal is tens of μm at the highest. Hence, the slight displacement is within a range of a play in assembling or elastic deformation of a member. In a case where the brake squeal is generated, the main disc BDS (particularly, the main-disc outer surface Msd) and the auxiliary disc BDH (particularly, the auxiliary-disc inner surface Mhq) rub against each other in any direction of the contact surface (refer to a ballooned-out portion (A)). There is friction between contact surfaces of the main disc BDS and the auxiliary disc BDH, and thus brake squeal is reduced due to friction attenuation occurring when the discs rub against each other.

The main disc BDS and the auxiliary disc BDH are secured to the hat member HTB by the fastening member TKB. The main disc BDS and the auxiliary disc BDH are in a state of being capable of slight displacement relative to each other. In other words, at least one of the main disc BDS and the auxiliary disc BDH is attached to the hat member HTB so as to be capable of being slightly displaced with respect to the hat member HTB in a plane direction of the disc (a perpendicular direction to the rotation axis Jbd of the brake disc). For example, a diameter of the assembly hole (through-hole) Atk of the auxiliary disc BDH is larger than a diameter of the assembly hole (through-hole) Atk of the main disc BDS. Consequently, it is easy for the auxiliary disc BDH to move with respect to the hat member HTB in a contact surface direction. As described above, both of the disc members BDS and BDH are secured via the hat member HTB that is a separate member from the discs, and thereby it is possible to improve assemblability of the entire brake disc BRD.

Here, in a case where a part of the main disc BDS on the outer side with the air hole Avn as a reference is elongated in the rotation axis direction (toward the hat member HTB) and is secured in the inner-circumferential portion (outer inner-circumferential portion) Otb, the auxiliary disc BDH is provided on the outer side from the main disc BDS. In this disposition, shapes of the discs BDS and BDH are simplified, and it is possible to more improve the assemblability.

Further, a secured part of the main disc BDS and the auxiliary disc BDH to the hat member HTB (that is, a fastening position by the fastening member TKB) is positioned out of the sliding range Hms between the auxiliary disc BDH and the friction pad MPO and on an approaching side to the rotation axis Jbd of the discs BDH and BDS. Here, in a case where the auxiliary disc BDH rotates, the sliding range Hms is a band-like region in which the auxiliary disc BDH and the friction pad MPO are in contact with each other (refer to a shaded portion). The discs BDH and BDS are secured to each other out of the sliding range Hms, and thus contact between the fastening member TKB and the friction pad MPO is avoided. Hence, abrasion powder of the friction pad is unlikely to adhere to the discs, and thus it is possible to suppress the brake squeal due to the abrasion powder. Further, the discs are secured to each other on a side close to the rotation axis Jbd, and thus it is possible to reduce the brake disc BRD in size.

During the non-braking in which the vehicle wheel WH does not generate the braking force, the main disc BDS and the auxiliary disc BDH do not perform relative movement but rotate in a completely integral manner. In addition, in a case where the brake squeal is not generated even during the braking, relative displacement between the main disc BDS and the auxiliary disc BDH is not generated. However, when the brake squeal is generated in any one disc of the main disc BDS and the auxiliary disc BDH during the braking, relative displacement is periodically generated between the one disc and the other disc in which the brake squeal is not generated. Relative movement between the main disc BDS and the auxiliary disc BDH causes a friction force to be generated between the main-disc outer surface Msd and the auxiliary-disc inner surface Mhq. The friction force can suppress the generated brake squeal.

The main disc BDS and the auxiliary disc BDH which have different vibration characteristics (for example, natural frequency) from each other are employed such that the brake squeal is not generated simultaneously in the discs. Hence, in a case where the brake squeal is generated in any one disc of the main disc BDS and the auxiliary disc BDH, an increase in vibration by the other disc (that is, a resonance phenomenon) is avoided.

### Second Embodiment of Brake Disc According to Invention

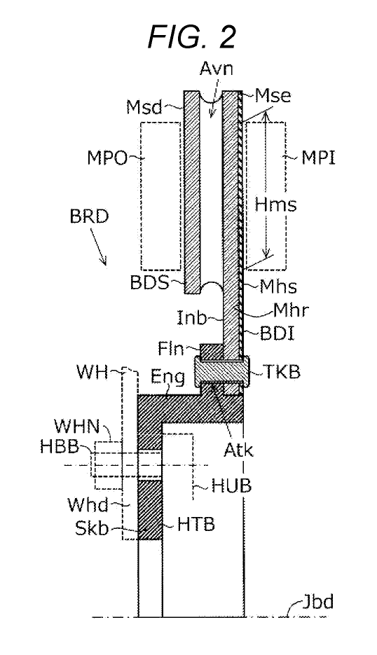

With reference to a sectional view in FIG. 2, a second embodiment of the brake disc BRD according to the invention will be described. A difference is as follows. In the first embodiment, the main disc BDS is secured to the hat member HTB in the outer inner-circumferential portion Otb; however, in the second embodiment, the main disc BDS is secured to the hat member HTB in an inner inner-circumferential portion Inb.

Each flat surface of the main disc BDS and an auxiliary disc BDI in the second embodiment will be described. In the main disc BDS, the flat surface (sliding surface) that is in contact with the outer pad MPO is the main-disc outer surface Msd. A flat surface on an opposite side (back side) of the main-disc outer surface Msd is the main-disc inner surface Mse. In the auxiliary disc BDI, the flat surface (sliding surface) that is in contact with the inner pad MPI is an auxiliary-disc inner surface Mhs. A flat surface on an opposite side (back side) of the auxiliary-disc inner surface Mhs is an auxiliary-disc outer surface Mhr.

The main disc BDS and the auxiliary disc BDI overlap each other so as to be secured to the hat member HTB by the fastening member TKB. The main-disc inner surface Mse and the auxiliary-disc outer surface Mhr are in surface contact with each other and are in a state of being capable of slight displacement relative to each other. The main-disc inner surface Mse and the auxiliary-disc outer surface Mhr are contact surfaces. During the braking, the main disc BDS and the auxiliary disc BDI receive a force so as to be sandwiched between the friction pads MPO and MPI. Hence, contact surface pressure of the main-disc inner surface Mse and the auxiliary-disc outer surface Mhr increases more during the braking than during the non-braking.

Similarly to the first embodiment, in a case where the brake squeal is generated, slight relative movement occurs between the main disc BDS and the auxiliary disc BDI. In this case, the friction force is generated between the main disc BDS and the auxiliary disc BDI. The friction force can attenuate the brake squeal.

The main disc BDS and the auxiliary disc BDI are provided with the plurality of assembly holes Atk in inner circumferential parts thereof so as to be assembled with the hat member HTB. The assembly holes Atk of the members are the through-holes. A part of the main disc on the inner side (side close to the center of the vehicle in the right-left direction) from the air hole Avn is elongated in the direction of the rotation axis Jbd (that is, the direction of the hat member HTB), and the assembly hole Atk of the main disc BDS is provided in the inner-circumferential portion Inb thereof. In other words, a connection portion between the main disc BDS and the hat member HTB is the inner inner-circumferential portion Inb. Thus, the auxiliary disc BDI is disposed on the inner side of the main disc BDS, and the main-disc inner surface Mse and the auxiliary-disc outer surface Mhr are in surface contact with each other.

A part of the main disc BDS on the inner side from the air hole Avn is elongated to the hat member HTB and is secured in the inner inner-circumferential portion Inb. In this disposition, shapes of the discs BDS and DBI are simplified, and the assemblability more improves. Additionally, a secured part of the main disc BDS and the auxiliary disc BDI to the hat member HTB (that is, a fastening position by the fastening member TKB) is positioned out of the sliding range Hms and on an approaching side to the disc rotation axis Jbd. Here, the sliding range Hms corresponds to a sliding part of the auxiliary disc BDI (particularly, the auxiliary-disc inner surface Mhs) and the friction pad MPI.

Further, a diameter of the assembly hole Atk of the auxiliary disc BDI can be set to be larger than the diameter of the assembly hole Atk of the main disc BDS such that the auxiliary disc BDI is easily displaced. Further, in order to avoid the brake squeal due to resonance, shapes, materials, or the like of the main disc BDS and the auxiliary disc BDI are selected such that the discs have different vibration characteristics (for example, natural frequency) from each other.

### Third Embodiment of Brake Disc According to Invention

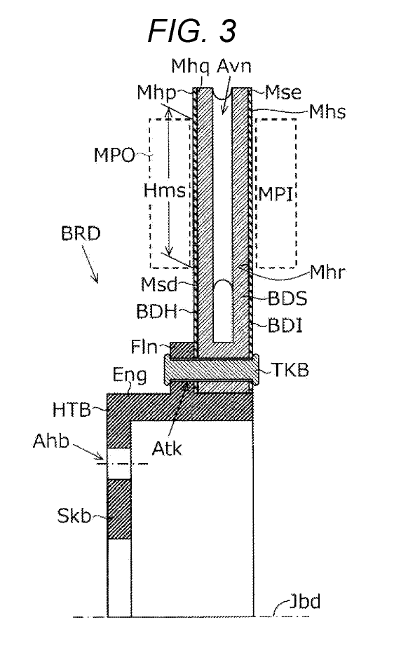

With reference to a sectional view in FIG. 3, a third embodiment of the brake disc BRD according to the invention will be described. In the first and second embodiments, the brake disc is configured from one main disc BDS and one auxiliary disc BDH; however, in the third embodiment, the brake disc is configured from one main disc BDS and two auxiliary discs BDH and BDI. Members (configurational elements) and the like, to which the same reference signs such as “BDS” are assigned, also have the same functions in the third embodiment. Hence, differences between the embodiments are mainly described.

In the brake disc BRD according to the third embodiment, a second auxiliary disc BDI is provided, in addition to a first auxiliary disc BDH. Specifically, the second auxiliary disc BDI is provided on the inner side from the main disc BDS, that is, an opposite side of the outer side on which the first auxiliary disc BDH is in contact with the main disc BDS. Similarly to the first auxiliary disc BDH, the second auxiliary disc BDI is also provided with the assembly holes (through-holes) Atk and is secured to the flange portion Fln of the hat member HTB by the fastening member TKB. Here, the auxiliary disc BDI (particularly, the auxiliary-disc outer surface Mhr) and the main disc BDS (particularly, the main-disc inner surface Mse) are in surface contact with each other (and are not in the point contact or line contact with each other) and are secured to each other in a state of being capable of slight displacement relative to each other (the displacement being larger than an amplitude of the brake squeal within a range of an assembling play or elastic deformation of a member, for example). In the third embodiment of the brake disc BRD, the two auxiliary discs BDH and BDI are in sliding contact with the friction pads MPI and MPO, and the main disc BDS does not directly slide against the friction pad.

Similarly to the first and second embodiments, the main disc BDS and the auxiliary discs BDH and BDI have different vibration characteristics (for example, natural frequency) from each other. This is to prevent the brake squeal from being caused due to the resonance phenomenon.

Also in the third embodiment, the same effects as those of the first and the second embodiments are achieved. In other words, in a case where the brake squeal is generated, the brake squeal is attenuated due to the friction between the main disc BDS and the first and second auxiliary discs BDH and BDI. In addition, it is possible to employ the hat member HTB such that the discs BDS, BDH, and BDI are assembled with the hat member HTB, and thus it is possible to improve assemblability of the entire brake disc BRD. Further, the fastening position by the fastening member TKB is provided at a position so as to avoid the sliding range Hms and approach the rotation axis Jbd. Therefore, the brake squeal due to the abrasion powder of the friction pads is suppressed, and it is possible to reduce the brake disc BRD (particularly, an outer radial shape) in size.

### Example of Auxiliary Disc

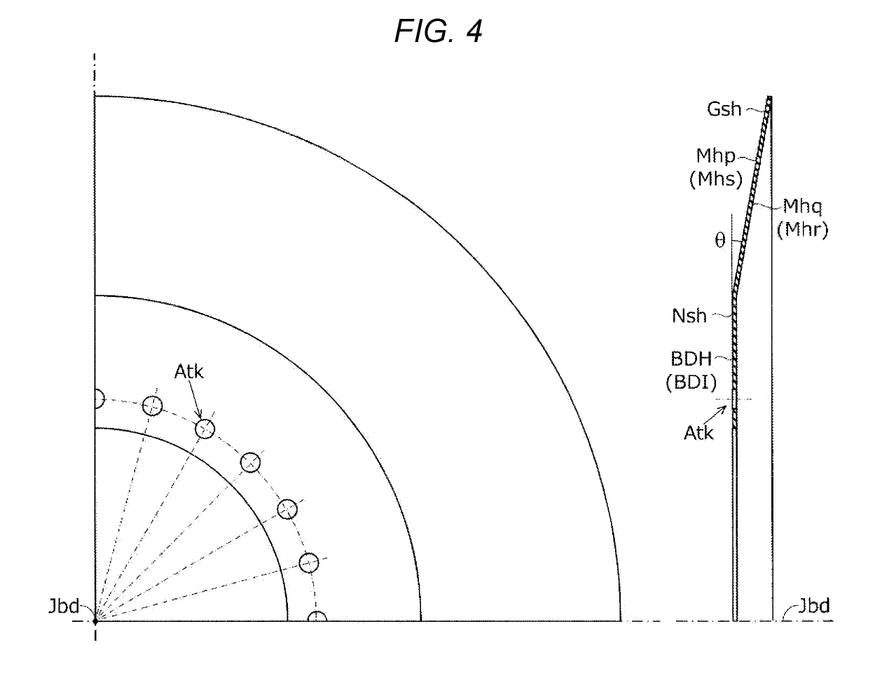

With reference to a partial sectional view in FIG. 4, an example (first example) of the auxiliary discs BDH and BDI will be described. The auxiliary disc BDH and the auxiliary disc BDI are basically the same as each other, and thus the description of the auxiliary disc BDH as an example is provided.

The auxiliary disc BDH is a thin plate (for example, a steel plate) and is secured to the hat member HTB at a relatively close position to the rotation axis Jbd. In a case where the braking is performed, the main disc BDS and the auxiliary disc BDH are pressed by the friction pads MPO (the outer side) and MPI (the inner side) and are in reliable surface contact with each other. However, during the non-braking, in a case where the main disc BDS and the auxiliary disc BDH are not secured to each other in an outer-circumferential portion (outer radial portion), a situation in which the main disc BDS and the auxiliary disc BDH are not in contact with each other can occur. In this case, when foreign matter such as grit enters a gap between the main disc BDS and the auxiliary disc BDH, a case where an expected friction attenuation effect is not achieved can occur. In order to avoid the occurrence of the case, prepressure (precompression) is applied to the contact surfaces such that the main disc BDS and the auxiliary disc BDH are in reliable contact with each other (with contact surface pressure).

Specifically, a “disc spring” shape is employed as a shape of the auxiliary disc BDH before assembling. A disc spring is a spring obtained by forming a disc-shaped plate having a hole open at the center thereof into a conical shape (three-dimensional cone shape having a circular bottom plane) and is also referred to as a diaphragm spring. Ina disc spring shape (conical shape) of the auxiliary disc BDH, a load is applied to an outer-circumferential portion Gsh on a bottom side and an inner-circumferential portion Nsh on a crest side, and the auxiliary disc is curved to be assembled in a direction in which a cone height decreases. Hence, the auxiliary-disc inner surface Mhq of the auxiliary disc BDH is secured in a state in which the precompression is maintained so as to be constantly pressed against the main-disc outer surface Msd of the main disc BDS.

The main disc BDS and the auxiliary disc BDH are in close contact with each other with surface pressure due to a spring action of the auxiliary disc BDH, and thus the above-described gap is not generated during the non-braking. Therefore, the brake disc BRD is capable of maintaining an effect of suppressing the brake squeal due to friction attenuation, over a long period.

The same disc spring shape as that of the auxiliary disc BDH is also employed as a shape of the auxiliary disc BDI. The auxiliary-disc outer surface Mhr of the auxiliary disc BDI is secured in a state in which the precompression is maintained so as to be constantly pressed against the main-disc inner surface Mse of the main disc BDS. As a result, it is possible to maintain the friction attenuation effect.

### Another Example of Auxiliary Disc

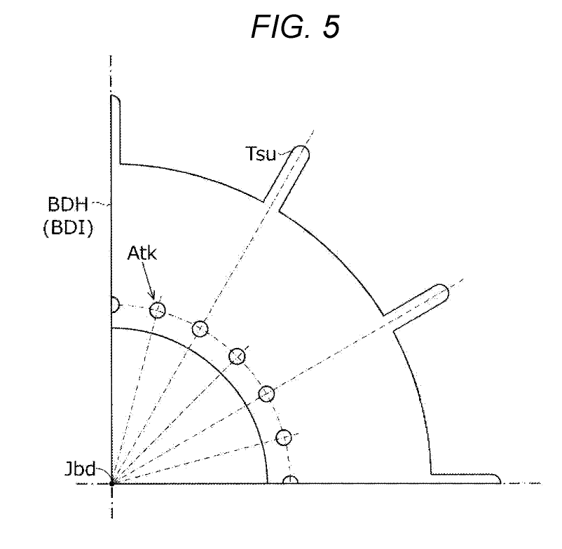

With reference to a schematic view in FIG. 5, another example (second example) of the auxiliary discs BDH and BDI will be described. Similarly to the first example, the auxiliary disc BDH and the auxiliary disc BDI are basically the same as each other, and thus the description of the auxiliary disc BDH as an example is also provided in the second example. A shape of the auxiliary disc BDH before assembling is illustrated in the drawing.

In a case where the braking is not performed, in order to avoid separation between the main disc BDS and the auxiliary disc BDH and generation of a gap therebetween, the outer-circumferential portion of the auxiliary disc BDH is provided with hook portions Tsu. During assembling of the brake disc, the hook portions Tsu are bent and hooked into the outer-circumferential portion of the main disc BDS. The outer-circumferential portion of the auxiliary disc BDH is secured to the outer-circumferential portion of the main disc BDS by the hook portions Tsu, and thus it is possible to suppress the generation of the above-described gap. Further, the disc spring shape described in the first example of the auxiliary disc BDH is employed, and the auxiliary disc BDH is provided with the hook portions Tsu and is fixed to the outer-circumferential portion of the main disc BDS. It is possible to achieve stronger surface contact between the main disc BDS and the auxiliary disc BDH.

<Operation⋅Effect>

Hereinafter, operations⋅effects of the above-described embodiments (first to third embodiments) of the invention will be described. The brake disc BRD applies braking torque to the vehicle wheel WH by sliding against the friction pads MPO and MPI. The brake disc BRD is configured from the main disc BDS, at least one auxiliary disc (one or more auxiliary discs BDH and BDI), and the hat member HTB.

The auxiliary disc BDH (the auxiliary disc BDI) slides against the friction pad MPO (the friction pad MPI). The flat surface on which the auxiliary disc BDH (BDI) slides against the friction pad MPO (MPI) is the sliding surface Mhp (Mhs). The main disc BDS is in surface contact with the auxiliary disc BDH (BDI) on the contact surface Mhq (Mhr) on an opposite side (back side) of the sliding surface Mhp (Mhs). In addition, the hat member HTB secures the main disc BDS and the auxiliary disc BDH (BDI) via the fastening member TKB so as to rotate integrally along with the discs in a state of being capable of slight displacement relative to each other. Specifically, the vehicle wheel WH, the hub unit HUB, the hat member HTB, the main disc BDS, and the auxiliary disc BDH (BDI) are coaxially secured. Hence, the disc rotation axis Jbd is the rotation axis of the vehicle wheel WH, the hub unit HUB, the hat member HTB, the main disc BDS, and at least one of the auxiliary discs BDH (BDI).

The “state of being capable of slight displacement” means that, in a case where the brake squeal is generated, the displacement larger than the amplitude of brake squeal is permitted between the discs. The amplitude is very low to be within the range of a play in assembling or elastic deformation of a member. Since the discs are capable of the slight displacement between each other, the main disc BDS and the auxiliary disc BDH (BDI) slide, with friction therebetween, in a case where the brake squeal is generated, and thereby the brake squeal is attenuated.

The main disc BDS is not configured from one member but is configured from two separate members of the main disc BDS (sliding member against the friction pad) and the hat member HTB (secured member to the vehicle wheel). As described above, the hat member HTB is employed such that the main disc BDS and at least one auxiliary disc (BDH and/or BDI) are secured to the hat member, and thus it is possible to improve an assembling property in the brake disc BRD.

Further, in a case where the brake disc BRD is configured from one main disc BDS and one auxiliary disc BDH, the auxiliary disc BDH is disposed on the outer side from the main disc BDS in a configuration in which the main disc BDS is attached to the hat member HTB in the inner-circumferential portion (connection portion) Otb on the outer side from the air hole Avn (on a side apart from the center of the vehicle in the right-left direction, that is, on the exterior side) (refer to FIG. 1). On the other hand, in a case where the main disc BDS is attached to the hat member HTB in the inner-circumferential portion (connection portion) Inb on the inner side from the air hole Avn (on a side close to the center of the vehicle in the right-left direction, that is, on the interior side), the auxiliary disc BDI is disposed on the inner side from the main disc BDS (refer to FIG. 2). A relationship between the attachment of the main disc BDS (the position of the connection portions Otb and Inb) and the disposition of the auxiliary discs BDH and BDI causes the shape of each disc to be simplified and an assembling property to further improve.

The main disc BDS and the auxiliary discs BDH and BDI are fastened to the hat member HTB out of the sliding range Hms of the auxiliary discs BDH and BDI against the friction pads MPO and MPI, on the side close to the rotation axis Jbd of the brake disc, with the sliding range Hms as the reference. A fastening portion by the fastening member TKB does not overlap the sliding range Hms, and thus the abrasion powder of the friction pads is not accumulated in the fastening part. Therefore, it is possible to avoid the brake squeal due to the abrasion powder. Further, the fastening part is positioned on the side close to the disc rotation axis Jbd, and thus it is possible to reduce the outer diameter of the brake disc BRD in size.

In order to improve a cooling property of the brake disc BRD, the main disc BDS is provided with air holes Avn. The above-described fastening position is avoided from the sliding range Hms and, in this respect, is disposed in the vicinity of the disc rotation axis Jbd. Consequently, in a case where the main disc BDS is provided with the air holes Avn, interference of the fastening portion with the air holes Avn is avoided, and thus it is possible to ensure the cooling property of the disc. Incidentally, in a case where the air hole is employed in a brake disc described in Patent Document 1, an assembling rivet interferes with the air hole, and thus it is difficult to assemble a main disc and an auxiliary disc. Otherwise, it is possible to impair the cooling property even when assembling is performed.

It is possible to employ materials and shapes of the main disc BDS and the auxiliary discs BDH and BDI so as to obtain different vibration characteristics such as natural frequency from each other. Consequently, it is possible to avoid the brake squeal due to the resonance between the discs.

The “disc spring” shape is employed as shapes of the auxiliary discs BDH and BDI before assembling (refer to FIG. 4). The main disc BDS and the auxiliary discs BDH and BDI are in close contact with each other in a state of maintaining the precompression due to a spring action of the auxiliary discs BDH and BDI. Therefore, no gap is generated between the main disc BDS and the auxiliary discs BDH and BDI during the non-braking. Asa result, it is possible to maintain an effect of suppressing the brake squeal due to the friction attenuation, over a long period.

The outer-circumferential portions of the auxiliary discs BDH and BDI are provided with the hook portions Tsu, and the hook portions Tsu are bent during assembling and hooked into the outer-circumferential portion of the main disc BDS (refer to FIG. 5). In this configuration, in a case where the braking is not performed, it is possible to cancel the surface contact between the main disc BDS and the auxiliary discs BDH and BDI and to avoid the generation of the gap therebetween.

### Modification Example

A solid disc without the air hole Avn is employed as the main disc BDS, instead of the ventilated disc provided with the cooling air holes Avn. Even in a case where the solid disc is employed, the same effects are achieved.

Caulked securing is exemplified as joining between the main disc BDS and the auxiliary discs BDH and BDI; however, it is possible to employ combining with a bolt and nut, instead of the caulked securing. In addition, instead of the caulked securing, it is possible to perform securing by performing welding (for example, spot welding). Further, in a case where one of the main disc BDS and the hat member HTB is cast, the auxiliary discs BDH and BDI can be cast and secured therein. Even in such a securing method, the slight displacement relative to each other is ensured, and the same effects are achieved.

### Fourth Embodiment of Brake Disc According to Invention

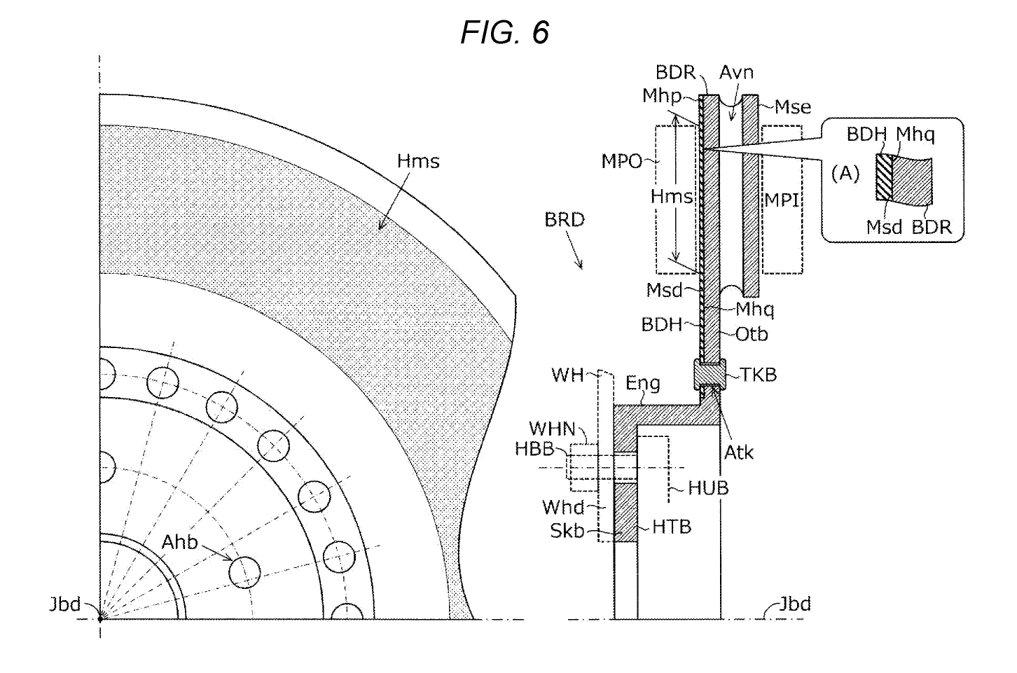

With reference to a partial sectional view in FIG. 6, a fourth embodiment of the brake disc BRD according to the invention will be described. The brake disc BRD is a friction disc of a disc-type braking device that is employed to brake the vehicle wheel WH in the vehicle.

The brake disc BRD is secured to rotate integrally along with the vehicle wheel WH, by the hub bolt HBB embedded in the hub unit HUB. Specifically, the hub bolt HBB extending from the hub unit HUB penetrates the attachment hole Ahb that is open in the brake disc BRD and the wheel disc portion Whd of the vehicle wheel WH and is fastened by the wheel nut WHN.

The brake disc BRD is sandwiched between the two friction pads MPO and MPI. Here, the outer-side pad MPO is positioned on the side close to the wheel disc portion Whd of the vehicle wheel WH (that is, the exterior side of the vehicle in the right-left direction), and the inner-side pad MPI is positioned on the side farther apart from the wheel disc portion Whd of the vehicle wheel WH (that is, the interior side of the vehicle in the right-left direction). The brake disc BRD is sandwiched between the friction pads MPO and MPI, and the friction force is generated during braking. The vehicle wheel WH exhibits the braking force due to the friction force.

The brake disc BRD is configured from a main disc BDR, the auxiliary disc BDH, and the fastening member TKB. Incidentally, the “outer side” indicates the exterior side of the vehicle in the right-left direction, and the “inner side” indicates the interior side of the vehicle in the right-left direction.

The main disc BDR has a bottomed cylindrical shape extending in the rotation axis Jbd direction (the rotation axis being the same as the rotation axis of the vehicle wheel WH) of the brake disc in an inner-circumferential portion of the main disc. The main disc is molded into an annular shape in a radial direction (perpendicular direction to the rotation axis Jbd of the vehicle wheel WH) from the cylindrical portion Eng of the main disc BDR. In other words, the main disc BDR has a hat shape (brimmed hat shape), a brim portion is a sliding part against the friction pad, and a crown portion corresponds to the cylindrical part Eng.

The hub unit HUB is provided inside the cylindrical portion Eng. The bottom portion Skb of the cylindrical portion Eng is provided with the plurality of attachment holes (through-holes) Ahb. The hub bolt HBB of the hub unit HUB penetrates the attachment hole Ahb and is tightened by the wheel nut WHN, with the wheel disc Whd of the vehicle wheel WH pinched therebetween. In other words, the hub unit HUB, the main disc BDR, and the vehicle wheel WH are integrally joined by the hub bolt HBB and the wheel nut WHN.

An outer-circumferential portion of the main disc BDR has a disc shape. The main-disc inner surface Mse (flat surface) that is positioned on the outer-circumferential portion is in sliding contact with the inner-side friction pad MPI. In addition, the outer-circumferential portion of the main disc BDR is provided with the plurality of air holes (passages of air) Avn therein for dissipating heat. The main disc BDR is a so-called ventilated disc. A part of the main disc BDR on the outer side (side apart from the center of the vehicle in the right-left direction) from the air hole Avn is elongated in the direction of the rotation axis Jbd and is connected to the cylindrical part Eng. The auxiliary disc BDH is fixed to the connection part Otb. For example, it is possible to employ cast iron as a material of the main disc BDR. This is because the cast iron has a high vibration damping property.

The auxiliary disc BDH is a member having the thin plate shape formed into the annular shape and overlaps the main disc BDR so as to be in surface contact therewith. Hence, the main disc BDR and the auxiliary disc BDH are not in point contact or line contact with each other. Similarly to the main disc BDR, the auxiliary disc BDH integrally rotates along with the vehicle wheel WH. The auxiliary disc BDH is in sliding contact with the outer-side friction pad MPO on the auxiliary-disc outer surface Mhp (flat surface) that is positioned on the outer-circumferential portion such that the vehicle wheel WH (tire) generates the braking force. Here, in a case where the brake disc BRD rotates, a part in which the auxiliary disc BDH and the friction pad MPO slide against each other is the sliding range Hms. For example, it is possible to employ a steel plate as a material of the auxiliary disc BDH. Incidentally, the auxiliary disc BDH is not provided with the air hole.

Each flat surface of the main disc BDR and the auxiliary disc BDH will be described. In the main disc BDR, the flat surface (sliding surface) that is in contact with the inner pad MPI is the main-disc inner surface Mse. A flat surface on an opposite side (back side) of the main-disc inner surface Mse is the main-disc outer surface Msd. In the auxiliary disc BDH, the flat surface (sliding surface) that is in contact with the outer pad MPO is the auxiliary-disc outer surface Mhp. A flat surface on an opposite side (back side) of the auxiliary-disc outer surface Mhp is the auxiliary-disc inner surface Mhq.

The main disc BDR and the auxiliary disc BDH overlap each other. Therefore, the main-disc outer surface Msd and the auxiliary-disc inner surface Mhq are in surface contact with each other. The main-disc outer surface Msd and the auxiliary-disc inner surface Mhq are contact surfaces. During the braking, the main disc BDR and the auxiliary disc BDH receive a force so as to be sandwiched between the friction pads MPO and MPI. Hence, contact surface pressure of the main-disc outer surface Msd and the auxiliary-disc inner surface Mhq increases more during the braking than during non-braking.

The auxiliary disc BDH is provided with the plurality of assembly holes Atk in inner circumferential parts thereof so as to be assembled with the main disc BDR. The plurality of assembly holes Atk are also open in the connection portion Otb of the main disc BDR so as to correspond to the assembly holes Atk of the auxiliary disc BDH. The assembly hole Atk is a through-hole in each of the disc members BDR and BDH.

The fastening member TKB penetrates the assembly hole Atk of each of the disc members BDR and BDH. Thus, the two disc members BDR and BDH are fastened by the fastening member TKB. Specifically, the fastening member TKB is a caulking member (for example, a rivet or a grommet), and an end portion thereof is plastically deformed. In this manner, the main disc BDR and the auxiliary disc BDH are secured to each other. In other words, the brake disc BRD is formed as one disc in which the two discs (the main disc BDR and the auxiliary disc BDH) overlap each other and are secured by the fastening member TKB. A hole diameter of the assembly hole Atk is slightly larger than a diameter of the fastening member TKB in a penetrating portion. Therefore, in a secured state in the direction of the disc rotation axis Jbd, the main disc BDR and the auxiliary disc BDH are in a state of being capable of slight displacement relative to each other within a contact surface. The vehicle wheel WH, the hub unit HUB, the main disc BDR, and the auxiliary disc BDH are coaxially secured. Hence, the disc rotation axis Jbd is the rotation axis of the vehicle wheel WH, the hub unit HUB, the main disc BDR, and the auxiliary disc BDH.

The “slight displacement” is displacement larger than an amplitude of brake squeal in a case where the brake squeal is generated. The brake squeal is tens of μm at the highest. Hence, the slight displacement is within a range of a play in assembling or elastic deformation of a member. In a case where the brake squeal is generated, the main disc BDR (particularly, the main-disc outer surface Msd) and the auxiliary disc BDH (particularly, the auxiliary-disc inner surface Mhq) rub against each other in any direction of the contact surface (refer to the ballooned-out portion (A)). There is friction between contact surfaces of the main disc BDR and the auxiliary disc BDH, and thus the brake squeal is reduced due to friction attenuation occurring when the discs rub against each other.

A secured part of the auxiliary disc BDH to the main disc BDR (that is, a fastening position by the fastening member TKB) is positioned out of the sliding range Hms between the auxiliary disc BDH and the friction pad MPO, on an approaching side to the rotation axis Jbd of the discs BDR and BDH from the sliding range Hms. Here, in a case where the auxiliary disc BDH rotates, the sliding range Hms is a band-like region in which the auxiliary disc BDH and the friction pad MPO are in contact with each other (refer to a shaded portion). The disc BDH is secured out of the sliding range Hms. Therefore, positional interference between the air holes Avn with the fastening member TKB is prevented, and contact between the fastening member TKB and the friction pad MPO is avoided. Hence, the sufficient cooling property is ensured, abrasion powder of the friction pad is unlikely to adhere to the discs, and it is possible to suppress the brake squeal due to the abrasion powder. Further, the discs are secured to each other on a side close to the disc rotation axis Jbd, and thus it is possible to reduce the brake disc BRD in size.

Here, in a case where the main disc BDR is secured in the disc connection portion Otb on the outer side from the air hole Avn, the auxiliary disc BDH is provided on the outer side from the main disc BDR. Specifically, the connection portion Otb is a part of the main disc BDR, which is elongated in the direction of the rotation axis Jbd from the outer side with respect to the air hole Avn and is connected to the cylindrical part Eng, and the assembly holes Atk are open in the connection portion Otb. Thus, the auxiliary disc BDH is assembled from the outer side. In this disposition, shapes of the discs BDR and DBH are simplified, and it is possible to more improve the assemblability.

During the non-braking in which the vehicle wheel WH does not generate the braking force, the main disc BDR and the auxiliary disc BDH do not perform relative movement but rotate in a completely integral manner. In addition, in a case where the brake squeal is not generated even during the braking, relative displacement between the main disc BDR and the auxiliary disc BDH is not generated. However, when the brake squeal is generated in any one disc of the main disc BDR and the auxiliary disc BDH during the braking, relative displacement is periodically generated between the one disc and the other disc in which the brake squeal is not generated. Relative movement between the main disc BDR and the auxiliary disc BDH causes a friction force to be generated between the main-disc outer surface Msd and the auxiliary-disc inner surface Mhq. The friction force can suppress the generated brake squeal.

The main disc BDR and the auxiliary disc BDH which have different vibration characteristics (for example, natural frequency) from each other are employed such that the brake squeal is not generated simultaneously in the discs. Hence, in a case where the brake squeal is generated in any one disc of the main disc BDR and the auxiliary disc BDH, an increase in vibration by the other disc (that is, a resonance phenomenon) is avoided.

### Fifth Embodiment of Brake Disc According to Invention

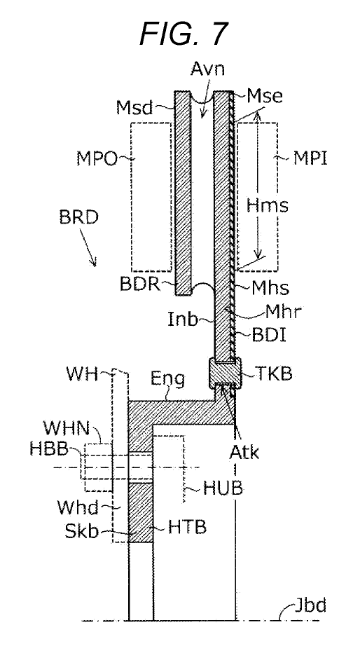

With reference to a sectional view in FIG. 7, a second embodiment of the brake disc BRD according to the invention will be described. A difference is as follows. In the first embodiment, the connection portion Otb of a disc portion (sliding portion) to the cylindrical portion in the main disc BDR is on extension of the disc on the outer side from the air hole Avn; however, in the fifth embodiment, the connection portion Inb is on extension of the disc on the inner side of the main disc BDR from the air hole Avn.

Each flat surface of the main disc BDR and the auxiliary disc BDI in the fifth embodiment will be described. In the main disc BDR, the flat surface (sliding surface) that is in contact with the outer pad MPO is the main-disc outer surface Msd. A flat surface on an opposite side (back side) of the main-disc outer surface Msd is the main-disc inner surface Mse. In the auxiliary disc BDI, the flat surface (sliding surface) that is in contact with the inner pad MPI is the auxiliary-disc inner surface Mhs. The flat surface on the opposite side (back side) of the auxiliary-disc inner surface Mhs is the auxiliary-disc outer surface Mhr.

The main disc BDR and the auxiliary disc BDI overlap each other. The auxiliary disc BDI is secured to the main disc BDR by the fastening member TKB. The main-disc inner surface Mse and the auxiliary-disc outer surface Mhr are in surface contact with each other and are in a state of being capable of slight displacement relative to each other. The main-disc inner surface Mse and the auxiliary-disc outer surface Mhr are contact surfaces. During the braking, the main disc BDR and the auxiliary disc BDI receive a force so as to be sandwiched between the friction pads MPO and MPI. Hence, contact surface pressure of the main-disc inner surface Mse and the auxiliary-disc outer surface Mhr increases more during the braking than during the non-braking.

Similarly to the fourth embodiment, in a case where the brake squeal is generated, slight relative movement occurs between the main disc BDR and the auxiliary disc BDI. In this case, a friction force is generated between the main disc BDR and the auxiliary disc BDI. The friction force can attenuate the brake squeal.

The auxiliary disc BDI is provided with the plurality of assembly holes Atk in inner circumferential parts thereof so as to be assembled with the main disc BDR. In addition, the plurality of assembly holes Atk are also provided in the main disc BDR so as to correspond to the assembly holes Atk of the auxiliary disc BDI. The assembly holes Atk of the disc members are the through-holes.

A secured part of the auxiliary disc BDI to the main disc BDR (that is, a fastening position by the fastening member TKB) is positioned out of the sliding range Hms between the auxiliary disc BDI and the friction pad MPI and on an approaching side to the rotation axis Jbd of the main disc from the sliding range Hms. This disposition causes the fastening member TKB, the air holes Avn, and the friction pad MPI to avoid positional interference with each other. As a result, the cooling property of the discs through the air holes is ensured, abrasion powder of the friction pad is unlikely to adhere to the discs, and it is possible to suppress the brake squeal due to the abrasion powder. Further, the discs are secured to each other on a part close to the rotation axis Jbd, and thus it is possible to reduce the brake disc BRD in size.

The assembly hole Atk of the main disc BDR is provided in the connection portion Inb on the inner side (side close to the center of the vehicle in the right-left direction) from the air hole Avn. In other words, the disc portion of the main disc BDR on the inner side is elongated in the direction of the rotation axis Jbd so as to be connected to the cylindrical portion Eng. In addition, the auxiliary disc BDI is disposed on the inner side of the main disc BDR, and the main-disc inner surface Mse and the auxiliary-disc outer surface Mhr are in surface contact with each other.

The above-described disposition is employed in a configuration in which the main disc BDR is secured in the connection portion Inb on the inner side. In this manner, the disc shape is simplified, and the assemblability more improves. Incidentally, in addition, a diameter of the assembly hole Atk of the auxiliary disc BDI can be set to be larger than a diameter of the assembly hole Atk of the main disc BDR such that the auxiliary disc BDI is easily displaced. Further, in order to avoid the brake squeal due to resonance, shapes, materials, or the like of the main disc BDR and the auxiliary disc BDI are selected such that the discs have different vibration characteristics (for example, natural frequency) from each other.

### Sixth Embodiment of Brake Disc According to Invention

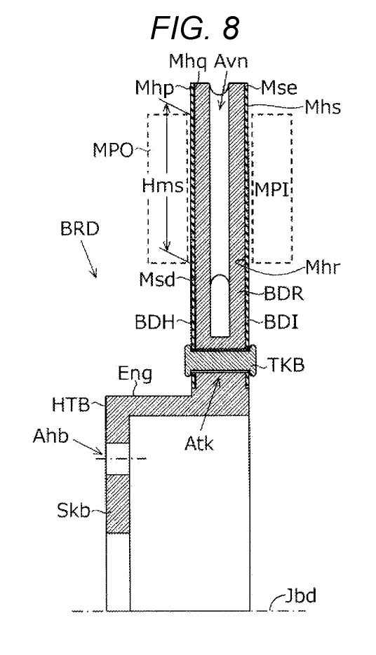

With reference to a sectional view in FIG. 8, a sixth embodiment of the brake disc BRD according to the invention will be described. In the fourth and fifth embodiments, the brake disc is configured from one main disc BDR and one auxiliary disc BDH; however, in the sixth embodiment, the brake disc is configured from one main disc BDR and two auxiliary discs BDH and BDI. Members (configurational elements) and the like, to which the same reference signs such as “BDR” are assigned, also have the same functions in the sixth embodiment. Hence, differences between the embodiments are mainly described.

In the brake disc BRD according to the sixth embodiment, the second auxiliary disc BDI is provided, in addition to the first auxiliary disc BDH. Specifically, the second auxiliary disc BDI is provided on the inner side from the main disc BDR, that is, an opposite side of the outer side on which the first auxiliary disc BDH is in contact with the main disc BDR. Similarly to the first auxiliary disc BDH, the second auxiliary disc BDI is also provided with the assembly holes (through-holes) Atk and is secured to the main disc BDR by the fastening member TKB. Here, the auxiliary disc BDI (particularly, the auxiliary-disc outer surface Mhr) and the main disc BDR (particularly, the main-disc inner surface Mse) are in surface contact with each other (and are not in the point contact or line contact with each other) and are secured to each other in a state of being capable of slight displacement relative to each other (the displacement being larger than an amplitude of the brake squeal within a range of an assembling play or elastic deformation of a member, for example). In the sixth embodiment of the brake disc BRD, the two auxiliary discs BDH and BDI are in sliding contact with the friction pads MPI and MPO, and the main disc BDR does not directly slide against the friction pad.

Similarly to the fourth and fifth embodiments, the main disc BDR and the auxiliary discs BDH and BDI have different vibration characteristics (for example, natural frequency) from each other. This is to prevent the brake squeal from being caused due to the resonance phenomenon.

Also in the sixth embodiment, the same effects as those of the fourth and fifth embodiments are achieved. In other words, in a case where the brake squeal is generated, the brake squeal is attenuated due to the friction between the main disc BDR and the first and second auxiliary discs BDH and BDI. In addition, an assembled position of the auxiliary discs BDH and BDI to the main disc BDR (the fastening position) is positioned by avoiding the sliding range Hms and is selected as a position close to the disc rotation axis Jbd from the sliding range Hms. In other words, the fastening position by the fastening member TKB is disposed to avoid the sliding range Hms and approach the rotation axis Jbd. Therefore, the cooling property is ensured, the brake squeal due to the abrasion powder of the friction pads is suppressed, and it is possible to reduce the brake disc BRD (particularly, an outer radial shape) in size.

### Example of Auxiliary Disc

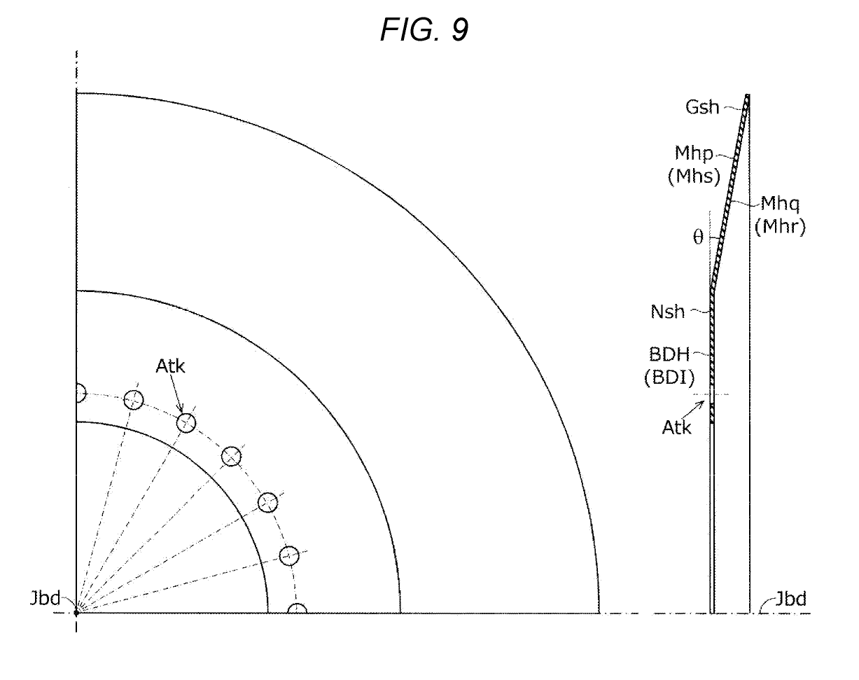

With reference to a partial sectional view in FIG. 9, an example (first example) of the auxiliary discs BDH and BDI will be described. The auxiliary disc BDH and the auxiliary disc BDI are basically the same as each other, and thus the description of the auxiliary disc BDH as an example is provided.

The auxiliary disc BDH is a thin plate (for example, a steel plate) and is secured to the main disc BDR at a relatively close position to the rotation axis Jbd. In a case where the braking is performed, the main disc BDR and the auxiliary disc BDH are pressed by the friction pads MPO (the outer side) and MPI (the inner side) and are in reliable surface contact with each other. However, during the non-braking, in a case where the main disc BDR and the auxiliary disc BDH are not secured to each other in an outer-circumferential portion (outer radial portion), a situation in which the main disc BDR and the auxiliary disc BDH are not in contact with each other can occur. In this case, when foreign matter such as grit enters a gap between the main disc BDR and the auxiliary disc BDH, a case where an expected friction attenuation effect is not achieved can occur. In order to avoid the occurrence of the case, prepressure (precompression) is applied to the contact surfaces such that the main disc BDR and the auxiliary disc BDH are in reliable contact with each other (with contact surface pressure).

Specifically, a “disc spring” shape is employed as a shape of the auxiliary disc BDH before assembling. A disc spring is a spring obtained by forming a disc-shaped plate having a hole open at the center thereof into a conical shape (three-dimensional cone shape having a circular bottom plane) and is also referred to as a diaphragm spring. In the disc spring shape (conical shape) of the auxiliary disc BDH, a load is applied to the outer-circumferential portion Gsh on the bottom side and the inner-circumferential portion Nsh on the crest side, and the auxiliary disc is curved to be assembled in a direction in which a cone height decreases. Hence, the auxiliary-disc inner surface Mhq of the auxiliary disc BDH is secured in a state in which the precompression is maintained so as to be constantly pressed against the main-disc outer surface Msd of the main disc BDR.

The main disc BDR and the auxiliary disc BDH are in close contact with each other with surface pressure due to the spring action of the auxiliary disc BDH, and thus the above-described gap is not generated during the non-braking. Therefore, the brake disc BRD is capable of maintaining an effect of suppressing the brake squeal due to friction attenuation, over a long period.

The same disc spring shape as that of the auxiliary disc BDH is also employed as a shape of the auxiliary disc BDI. The auxiliary-disc outer surface Mhr of the auxiliary disc BDI is secured in a state in which the precompression is maintained so as to be constantly pressed against the main-disc inner surface Mse of the main disc BDR. As a result, it is possible to maintain the friction attenuation effect.

### Another Example of Auxiliary Disc

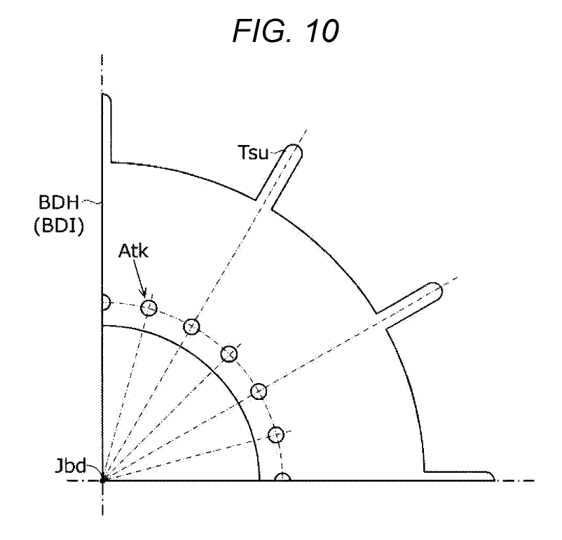

With reference to a schematic view in FIG. 10, another example (second example) of the auxiliary discs BDH and BDI will be described. Similarly to the first example, the auxiliary disc BDH and the auxiliary disc BDI are basically the same as each other, and thus the description of the auxiliary disc BDH as an example is also provided in the second example. A shape of the auxiliary disc BDH before assembling is illustrated in the drawing.

In a case where the braking is not performed, in order to avoid separation between the main disc BDR and the auxiliary disc BDH and generation of a gap therebetween, the outer-circumferential portion of the auxiliary disc BDH is provided with the hook portions Tsu. During assembling of the brake disc, the hook portions Tsu are bent and hooked into the outer-circumferential portion of the main disc BDR. The outer-circumferential portion of the auxiliary disc BDH is secured to the outer-circumferential portion of the main disc BDR by the hook portions Tsu, and thus it is possible to suppress the generation of the above-described gap. Further, the disc spring shape described in the first example of the auxiliary disc BDH is employed, and the auxiliary disc BDH is provided with the hook portions Tsu and is fixed to the outer-circumferential portion of the main disc BDR. It is possible to achieve stronger surface contact between the main disc BDR and the auxiliary disc BDH.

### Seventh to Ninth Embodiments of Brake Disc According to Invention

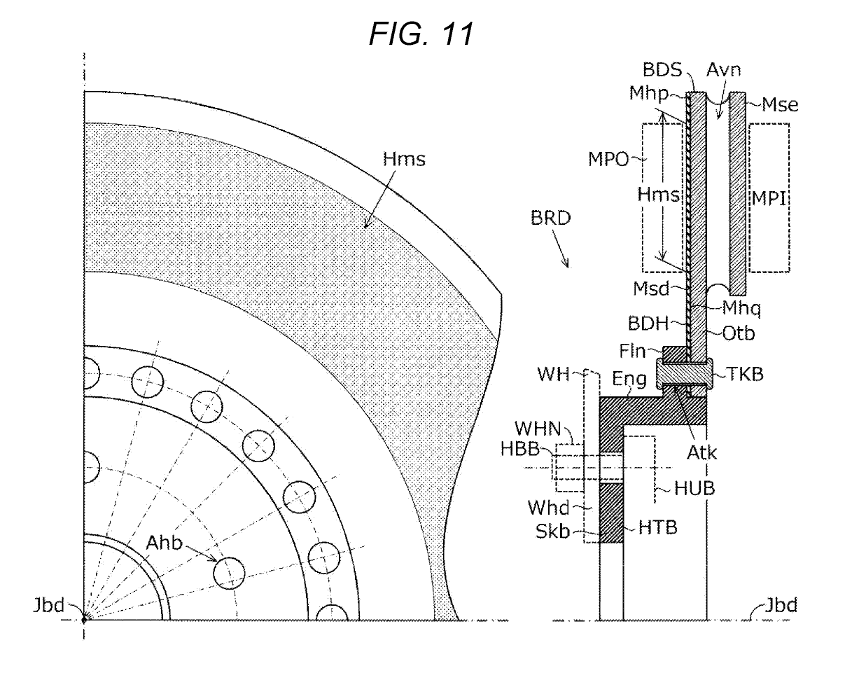

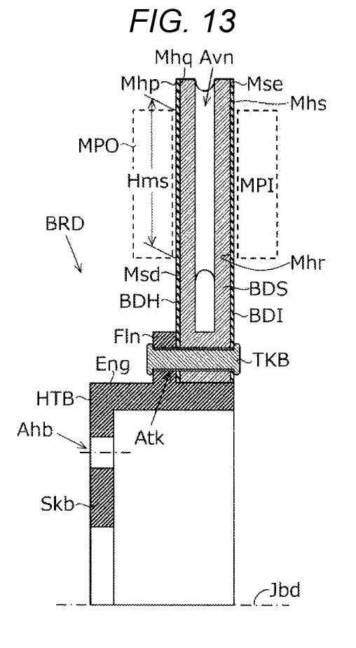

With reference to sectional views in FIGS. 11 to 13, seventh to ninth embodiments of the brake disc BRD according to the invention are described. In the fourth to sixth embodiments, the brake disc is configured from a single member of the main disc BDR; however, in the seventh to ninth embodiments, the brake disc is configured from two separate members of the main disc BDS and the hat member HTB. FIGS. 11, 12, and 13 correspond to FIGS. 6, 7, and 8, respectively. Members (configurational elements) and the like, to which the same reference signs such as “BDH” are assigned, also have the same functions in the seventh to ninth embodiments. Hence, differences between the embodiments are mainly described.

The main disc BDS is molded into an annular shape. The main disc BDS is provided with the plurality of air holes (passages of air) Avn therein for dissipating heat. The auxiliary discs BDH and BDI are members having a thin plate shape formed into an annular shape and overlap the main disc BDS so as to be in surface contact therewith. In a case where the brake disc BRD rotates, the auxiliary discs BDH and BDI and the friction pads MPO and MPI slide against each other. This part is the sliding range Hms. Incidentally, the auxiliary disc BDH is not provided with the air hole.

The main disc BDS and the auxiliary discs BDH and BDI are provided with the plurality of assembly holes Atk in the inner circumferential parts thereof so as to be assembled with the hat member HTB. The assembly hole Atk is a through-hole in each of the disc members BDS, BDH, and BDI.

The hat member HTB is a bottomed cylindrical member that has the flange portion Fln in the outer-circumferential portion Eng and extends in the rotation axis Jbd direction of the brake disc (the rotation axis being the same as the rotation axis of the vehicle wheel WH). The hub unit HUB is provided inside a cylinder of the hat member HTB. The bottom portion Skb of the hat member HTB is provided with the plurality of attachment holes (through-holes) Ahb. The hub bolt HBB of the hub unit HUB penetrates the attachment hole Ahb and is tightened by the wheel nut WHN, with the wheel disc Whd of the vehicle wheel WH pinched therebetween. In other words, the hub unit HUB, the hat member HTB, and the vehicle wheel WH are integrally joined.

The flange portion Fln of the hat member HTB is provided with the plurality of assembly holes (through-holes) Atk such that the main disc BDS and the auxiliary discs BDH and BDI are assembled with the hat member. The fastening member TKB penetrates the assembly hole Atk of each of the members HTB, BDS, BDH, and BDI. Thus, the members HTB, BDS, BDH, and BDI are fastened by the fastening member TKB. Specifically, the fastening member TKB is a caulking member (for example, a rivet or a grommet). A hole diameter of the assembly hole Atk is slightly larger than a diameter of the fastening member TKB in a penetrating portion. Therefore, in a secured state in the disc rotation axis Jbd direction, the main disc BDS and the auxiliary discs BDH and BDI are in a state of being capable of slight displacement relative to each other within contact surfaces. The vehicle wheel WH, the hub unit HUB, the hat member HTB, the main disc BDS, and the auxiliary discs BDH and BDI are coaxially secured. Hence, the disc rotation axis Jbd is the rotation axis of the vehicle wheel WH, the hub unit HUB, the hat member HTB, the main disc BDS, and at least one of the auxiliary discs BDH and BDI.

The “slight displacement” is displacement larger than the amplitude of the brake squeal in a case where the brake squeal is generated. For example, the slight displacement is within a range of a play in assembling or elastic deformation of a member. In a case where the brake squeal is generated, the main disc BDS and the auxiliary discs BDH and BDI rub against each other in any direction of contact surfaces. Thus, there is friction between contact surfaces of the main disc BDS and the auxiliary discs BDH and BDI, and thus the brake squeal is reduced due to friction attenuation occurring when the discs rub against each other.

The secured part of the main disc BDS and the auxiliary discs BDH and BDI to the hat member HTB (that is, the fastening position by the fastening member TKB) is positioned out of the sliding range Hms between the auxiliary discs BDH and BDI and the friction pads MPO and MPI and on an approaching position to the disc rotation axis Jbd from the sliding range Hms. It is possible to suppress the interference between the fastening positions and the air holes Avn by the disposition of the fastening positions, and it is possible to ensure the cooling property of the discs. In addition, the contact between the fastening member TKB and the friction pad MPO is avoided, the abrasion powder of the friction pad is unlikely to adhere to the discs, and it is possible to suppress the brake squeal due to the abrasion powder. Further, the discs are secured to each other on the side close to the rotation axis Jbd, and thus it is possible to reduce the brake disc BRD in size.

The disc members BDS, BDH and BDI are secured via the hat member HTB that is a separate member from the discs, and thereby it is possible to improve the assemblability of the entire brake disc BRD. The diameter of the assembly hole (through-hole) Atk of the auxiliary disc BDH is larger than the diameter of the assembly hole (through-hole) Atk of the main disc BDS. Consequently, it is easy for the auxiliary disc BDH to move with respect to the hat member HTB in a contact surface direction, and it is easy to obtain the friction attenuation effect.

The main disc BDS and the auxiliary discs BDH and BDI which have different vibration characteristics (for example, natural frequency) from each other are employed such that the brake squeal is not generated simultaneously in the discs. Hence, in a case where the brake squeal is generated in any one disc of the main disc BDS and the auxiliary discs BDH and BDI, an increase in vibration by another disc (that is, a resonance phenomenon) is avoided.

<Operation⋅Effect>

Hereinafter, operations⋅effects of the above-described embodiments (fourth to ninth embodiments) of the invention will be described. The brake disc BRD applies the braking torque to the vehicle wheel WH by sliding against the friction pads MPO and MPI. The brake disc BRD is configured from the main disc BDR (BDS) and at least one auxiliary disc (one or more auxiliary discs BDH and BDI).

The auxiliary disc BDH (the auxiliary disc BDI) slides against the friction pad MPO (the friction pad MPI). The flat surface on which the auxiliary disc BDH (BDI) slides against the friction pad MPO (MPI) is the sliding surface Mhp (Mhs). The main disc BDR (BDS) is in surface contact with the auxiliary disc BDH (BDI) on the contact surface Mhq (Mhr) on an opposite side (back side) of the sliding surface Mhp (Mhs). Thus, the main disc BDR and the auxiliary disc BDH (BDI) are secured with the fastening member TKB so as to integrally rotate in a state of being capable of slight displacement relative to each other. Specifically, the vehicle wheel WH, the hub unit HUB, the main disc BDR (BDS), and the auxiliary disc BDH (BDI) are coaxially secured. Hence, the disc rotation axis Jbd is the rotation axis of the vehicle wheel WH, the hub unit HUB, the main disc BDR (BDS), and at least one of the auxiliary discs BDH (BDI).

The “state of being capable of slight displacement” means that, in a case where the brake squeal is generated, the displacement larger than the amplitude of the brake squeal is permitted between the discs. The amplitude is very low to be within the range of a play in assembling or elastic deformation of a member. Since the discs are capable of the slight displacement between each other, the main disc BDR (BDS) and the auxiliary disc (BDH and/or BDI) slide, with friction therebetween, in a case where the brake squeal is generated, and thereby the brake squeal is attenuated.

The main disc BDR (BDS) and at least one of the auxiliary discs BDH and BDI are fastened out of the sliding range Hms of the auxiliary discs BDH and BDI against the friction pads MPO and MPI, on the side close to the rotation axis Jbd of the brake disc (for example, the main disc BDR or BDS), with the sliding range Hms as the reference. A fastening portion by the fastening member TKB does not overlap the sliding range Hms, and thus the abrasion powder of the friction pads is not accumulated in the fastening part. Therefore, it is possible to avoid the brake squeal due to the abrasion powder. Further, the fastening part is positioned at the position close to the disc rotation axis Jbd, and thus it is possible to reduce the outer diameter of the brake disc BRD in size.

In order to improve the cooling property of the brake disc BRD, the main disc BDR (BDS) can be provided with the air holes Avn. The fastening by the fastening member TKB is performed by avoiding a position of the air hole Avn, and thereby it is possible to ensure the sufficient cooling property. Incidentally, in a case where the air hole is employed in a brake disc described in Patent Document 1, an assembling rivet interferes with an air hole, and thus it is not possible to perform the assembling. In addition, even when the assembling is completed, the air hole interferes with the rivet. Therefore, the air hole does not exhibit the sufficient function, and thus it is possible to impair the cooling property.

The hat member HTB that is a separate member from the main disc BDS is employed (refer to FIGS. 11 to 13). The main disc BDS and the auxiliary discs BDH and BDI are secured to the hat member HTB. In this case, the hat member HTB, the main disc BDS, and the auxiliary discs BDH and BDI are integrated and rotate around the rotation axis Jbd. In this configuration, it is possible to improve the assembling property in the brake disc BRD. Even in the configuration, the main disc BDS is provided with the air holes Avn, and the fastening positions by the fastening member TKB is set by avoiding the sliding range Hms on the side close to the disc rotation axis Jbd from the sliding range Hms. It is possible to ensure cooling performance of the disc, to avoid the brake squeal due to the abrasion powder, and to reduce the brake disc BRD in size.

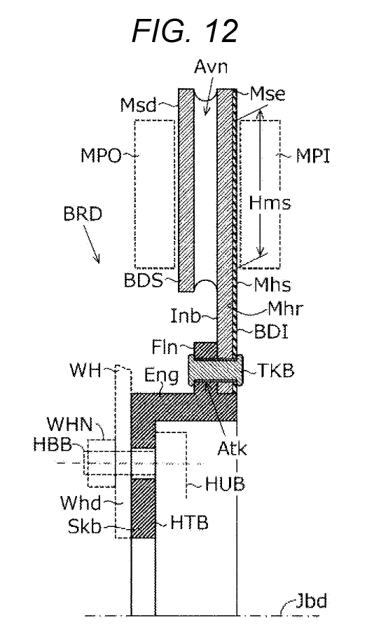

Further, in a case where the brake disc BRD is configured from one main disc and one auxiliary disc which are provided with the air holes Avn, the auxiliary disc BDH is disposed on the outer side from the main disc BDR or BDS in a configuration (the connection portion Otb) in which the part of the main disc BDR or BDS on the outer side (the side apart from the center of the vehicle in the right-left direction, that is, the exterior side) from the air holes Avn is elongated in the rotation axis direction so as to be connected to the cylindrical portion Eng (refer to FIGS. 6 and 11). On the other hand, in a configuration (connection portion Inb) in which the part of the main disc BDR or BDS on the inner side (the side close to the center of the vehicle in the right-left direction, that is, the interior side) from the air holes Avn is elongated in the rotation axis direction so as to be connected to the cylindrical portion Eng, the auxiliary disc BDI is disposed on the inner side from the main disc BDR or BDS (refer to FIGS. 7 and 12). In the relationship between the connection position (that is, the connection portion Otb or Inb) between the main disc BDR or BDS to the cylindrical portion Eng and dispositions of the auxiliary discs BDH and BDI, the shape of each disc is simplified, and thus the assembling property further improves.

It is possible to employ materials and shapes of the main disc BDR or BDS and the auxiliary discs BDH and BDI so as to obtain different vibration characteristics such as natural frequency from each other. Consequently, it is possible to avoid the brake squeal due to the resonance between the discs.

The “disc spring” shape is employed as shapes of the auxiliary discs BDH and BDI before assembling (refer to FIG. 9). The main disc BDR or BDS and the auxiliary discs BDH and BDI are in close contact with each other in a state of maintaining the precompression due to the spring action of the auxiliary discs BDH and BDI. Therefore, no gap is generated between the main disc BDR or BDS and the auxiliary discs BDH and BDI during the non-braking. As a result, it is possible to maintain an effect of suppressing the brake squeal due to the friction attenuation, over a long period.

The outer-circumferential portions of the auxiliary discs BDH and BDI are provided with the hook portions Tsu, and the hook portions Tsu are bent during assembling and hooked into the outer-circumferential portion of the main disc BDR or BDS (refer to FIG. 10). In this configuration, in a case where the braking is not performed, it is possible to cancel the surface contact between the main disc BDR or BDS and the auxiliary discs BDH and BDI and to avoid the generation of the gap therebetween.

### Modification Example

A solid disc without the air hole Avn is employed as the main disc BDR or BDS, instead of the ventilated disc provided with the cooling air holes Avn. Even in a case where the solid disc is employed, the same effects are achieved.

Caulked securing is exemplified as the joining between the main disc BDR or BDS and the auxiliary discs BDH and BDI; however, it is possible to employ combining with a bolt and nut, instead of the caulked securing. In addition, instead of the caulked securing, it is possible to perform securing by performing welding (for example, spot welding). Further, in a case where one of the main disc BDS and the hat member HTB is cast, the auxiliary discs BDH and BDI can be cast and secured therein. Even in such a securing method, the slight displacement relative to each other is ensured, and the same effects are achieved.

1. A brake disc that applies braking torque to a vehicle wheel by sliding against a friction pad, the brake disc comprising:
at least one auxiliary disc that slides against the friction pad; and
a main disc in surface contact with the auxiliary disc at a surface on a side opposite a surface against which the auxiliary disc and the friction pad slide, and
a hat member that secures the main disc and the auxiliary disc in a state of being capable of slight displacement relative to each other.

2. A brake disc that applies braking torque to a vehicle wheel by sliding against a friction pad, the brake disc comprising:
at least one auxiliary disc that is in contact with the friction pad; and
a main disc in surface contact with the auxiliary disc,
wherein the main disc and the auxiliary disc are secured in a state of being capable of slight displacement relative to each other, out of a sliding range between the auxiliary disc and the friction pad, on an approaching side to a rotation axis of the main disc from the sliding range.

3. The brake disc according to claim 2,
wherein the main disc is provided with an air hole.
